(19) United States
(12) Patent Application Publication
(10) Pub. No.: US 2019/0366728 A1
(43) Pub. Date: Dec. 5, 2019

(54) INK SUPPLY IN PRINTING DEVICES

(71) Applicant: HEWLETT-PACKARD DEVELOPMENT COMPANY, L.P., Spring, TX (US)

(72) Inventor: Cherng Linn Teo, Singapore (SG)

(73) Assignee: HEWLETT-PACKARD DEVELOPMENT COMPANY, L.P., Spring, TX (US)

(21) Appl. No.: 16/481,729

(22) PCT Filed: Apr. 27, 2017
(86) PCT No.: PCT/US2017/029773

§ 371 Date: Jul. 29, 2019

(51) Int. Cl. B41J 2/175

(52) U.S. Cl. CPC B41J 2/17556; B41J 2/17566

(57) ABSTRACT

The present subject matter discloses engagement and disengagement of a fluidic interconnect with an inlet port of an ink regulator. In an example implementation, a printing device includes a fluidic interconnect. The fluidic interconnect is to be engaged with an inlet port of an ink regulator of the printing device to supply ink to the ink regulator. After supplying the ink to the ink regulator, the fluidic interconnect is to be disengaged from the inlet port.

### BACKGROUND

Printing devices, such as inkjet printers print on a print medium by spraying ink on the print medium. Ink is supplied to a printhead of the printer which performs a printing operation on the print medium. Print quality may depend on ink supplied to the printhead,

### BRIEF DESCRIPTION OF DRAWINGS

The following detailed description references the drawings, wherein:

FIG. 1 illustrates an ink supply assembly for a printing device, according to an example implementation of the present subject matter;

FIG. 2 illustrates an ink supply assembly for a printing device, according to an example implementation of the present subject matter;

FIG. 3 illustrates an image forming unit of a printing device, according to an example implementation of the present subject matter;

FIG. 4A illustrates an ink regulator of a printing device, according to an example implementation of the present subject matter;

FIG. 4B illustrates an ink regulator of a printing device, according to an example implementation of the present subject matter;

FIG. 5 illustrates a printing device, according to an example implementation of the present subject matter; and

FIG. 6 illustrates a printing device, according to an example implementation of the present subject matter.

### DETAILED DESCRIPTION

A printing device, such as an inkjet printer includes a printhead for printing on a print media and ink cartridges or regulators for providing ink to the printhead. An ink regulator has a capacity for holding ink and has at least one outlet connected to the printhead for flowing ink to the printhead. The printhead and the ink regulator may be mounted on a carriage of the printer. The printhead and the ink regulator may move along with the carriage during printing.

In printers for home use, also called on-axis printers, which usually have a low print volume demand, the ink regulator is generally a single source of ink, Therefore, every time ink in the ink regulator is depleted, the ink regulator has to be replaced which interrupts the printing operations and increases downtime of the printer. Further, having an ink regulator of a larger size to enhance the ink holding capacity may result in increase in weight of the ink regulator and in turn increase in weight of the carriage. A heavier carriage may be unstable during its movement while printing. Although, a heavier carriage may be stabilized by use of carriage stabilizing means, use of such means may, however, result in higher loading or power consumption, and thereby may lead to heating up of motors and other electrical components inside the printer. Further, having an ink regulator of a larger size results in increase in size of the printer which affects the modularity of the on-axis printers and makes the printers cost intensive.

Printers for commercial use, also called off-axis printers, which usually have a high print volume demand, include an ink reservoir positioned inside the printer away from the carriage. The ink reservoir acts as a source of ink from where ink can be transferred to the ink regulator when ink in the ink regulator is depleted. One end of the ink regulator is connected to the printhead and other end is connected to the ink reservoir through a pipe or tube. When ink in the ink regulator is depleted, ink from the ink reservoir may be pumped through the pipe to the ink regulator. Thus, in off-axis printers there is a permanent connection between the ink regulator and the ink reservoir. During printing, when the ink regulator moves along with the carriage, the tube connecting the ink regulator with the ink reservoir is subjected to twist and bend forces because of the movement of the carriage. Twisting of the tube may lead to instability in movement of the carriage, may block flow of ink through the tube, and thereby adversely affect print quality. Also, due to the forces acting on the tube, there may be wear and tear of the tube which may reduce longevity of the tube and increase chances of faults due to damage of the tube. Further, the forces acting on the tube may also result in leaking of the tube and thereby lead to ink spillage and loss of ink.

In the present subject matter, approaches for an ink supply assembly for a printing device have been discussed. The ink supply assembly includes a fluidic interconnect, couplable to an ink reservoir, which can be moved to engage with an inlet port of an ink regulator to supply and fill ink from the ink reservoir into the ink regulator when the ink regulator is low on ink. An inlet port refers to an opening in the ink regulator which is configured to receive the fluidic interconnect for flowing ink into the ink regulator. When a prescribed volume of ink has been supplied and filled into the ink regulator, the fluidic interconnect can be moved to disengage from the inlet port. Thus, the ink supply assembly enables a dynamic make-break connection between the ink reservoir and the ink regulator.

The dynamic engagement and disengagement of the ink regulator with the ink reservoir through movement of the fluidic interconnect, in accordance with the present subject matter, avoids having a permanent connection between the ink regulator and the ink reservoir, as present in the off-axis printers. Thus, the use of tubes or pipes for forming the permanent connection is eliminated. Without tubes being used for the permanent connection, carriage instability associated with twisting of tubes may be reduced and issue of blocking of ink flow through the tubes is eliminated. Thus, print quality may be improved. Also, chances of leakage of the tubes and ink spillage are eliminated. Further, with the present subject matter, in contrast to the on-axis printers discussed earlier, the ink regulator need not be replaced every time ink in the ink regulator is depleted. Rather, when the ink regulator is low on ink, a fluidic interconnect coupled to the ink reservoir gets engaged with the inlet port of the ink regulator and thereby ink can be refilled in the ink regulator. Once the ink regulator is refilled, the fluidic interconnect may be disengaged from the inlet port.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

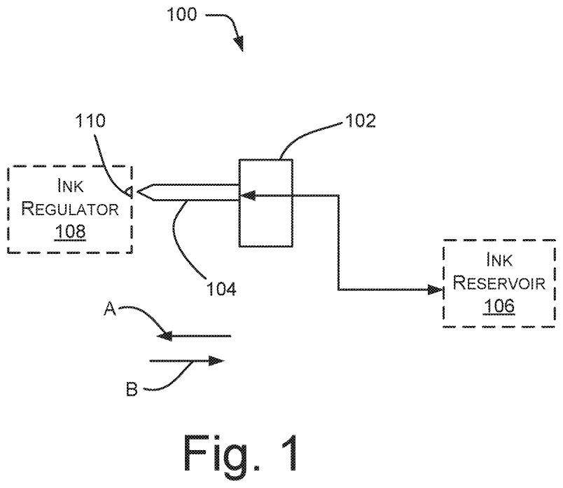

FIG. 1 illustrates an ink supply assembly 100 for a printing device, according to an example implementation of the present subject matter. The printing device may be a printer, such as an inkjet printer, a large format printer (LFP), a photocopier, or the like.

The ink supply assembly 100 includes a drive rack 102 and a fluidic interconnect 104 mounted on the drive rack 102. The drive rack is a mechanical arrangement for holding fluidic interconnects and for moving the fluidic interconnects within the printing device. In an example implementation, the fluidic interconnect 104 is a linearly extending rigid conduit for transporting ink. In an example implementation, the fluidic interconnect 104 may be a hollow metallic needle. The fluidic interconnect 104 is couplable to an ink reservoir 106 of the printing device. The ink reservoir 106 may include various chambers for holding inks of different colors. In an example implementation, the fluidic interconnect 104 may be connected to the chambers of the ink reservoir 106. Although in FIG. 1, the ink reservoir 106 is illustrated as being outside the ink supply assembly 100, in an example implementation, the ink reservoir may be a part of the ink supply assembly.

FIG. 1 also depicts an ink regulator 108 having an inlet port 110. In an example implementation, the ink regulator 108 may be mounted on a carriage (not shown in FIG. 1) of the printing device. The carriage may include a print head for printing. The ink regulator 108 may be coupled to the printhead for providing ink to the printhead. The inlet port 110 of the ink regulator 108 is configured to receive the fluidic interconnect 104.

When the ink regulator 108 has a volume of ink less that a predefined threshold, the drive rack 102 is operated to move the fluidic interconnect 104 in a first direction, as indicated by arrow A, to engage the fluidic interconnect 104 with the inlet port 110 of the ink regulator 108. This engagement between the fluidic interconnect 104 and the inlet port 110 enables ink from the ink reservoir 106 to be supplied and filled into the ink regulator 108.

In an example implementation, after supplying and filling the ink in the ink regulator 108, the drive rack 102 is operated to move the fluidic interconnect 104 in a second direction, as indicated by arrow B, to disengage the fluidic interconnect 104 from the inlet port 110, where the second direction is different from the first direction. In an example implementation, the second direction is opposite to the first direction as also depicted through arrows A and B. As explained above, the connection between the ink regulator 108 and the ink reservoir 106 is not a permanent connection rather it is a breakable connection which can be formed or disconnected depending on the level of ink in the ink regulator 108.

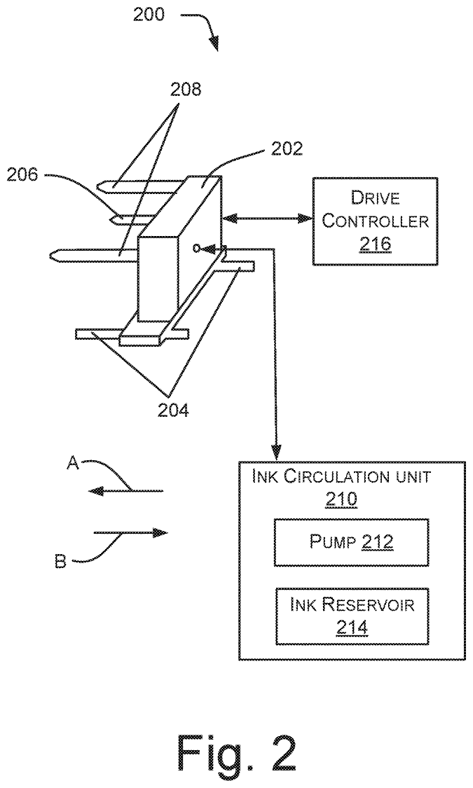

FIG. 2 illustrates an ink supply assembly 200 for a printing device, according to an example implementation of the present subject matter. In an example implementation, the ink supply assembly 100 of FIG. 1 may include the features of the ink supply assembly 200 illustrated in FIG. 2.

As shown in FIG. 2, the ink supply assembly 200 includes a drive rack 202. The drive rack 202 may be similar to the drive rack 102 of FIG. 1. The drive rack 202 is mounted on drive shafts 204 which can be actuated by Computer Numeric Control (CNC) stages (not shown). The drive rack 202 may hold a fluidic interconnect 206 similar to the fluidic interconnect 104 of FIG. 1.

In an example implementation, the drive rack 202 includes a plurality of guide pins 208 to align the fluidic interconnect 206 with an inlet port of an ink regulator, for example, the inlet port 110 of the ink regulator 108. In an example implementation, each of the guide pins 208 may be formed from metal and may be integral to the drive rack 202.

The ink supply assembly 200 further includes an ink circulation unit 210 coupled to an end of the fluidic interconnect 206. The ink circulation unit 210, as shown, includes a pump 212 and an ink reservoir 214. In an example implementation, an end of the fluidic interconnect 206 may be connected to the ink reservoir 214 through tubes. The ink reservoir 214 may have multiple chambers having different colors of ink and the fluidic interconnect 206 may be connected to one of such chambers.

In an example implementation, the pump 212 may be operated to flow ink from the ink reservoir 214 through the fluidic interconnect 206 and into an ink regulator, for example, the ink regulator 108. In an example implementation, the pump 212 may also be operated to draw out a mixture of air and ink from the ink regulator. Thus, the ink circulation unit 210 enables a continuous flow of ink through the ink supply assembly 200, to provide ink circulation as in continuous ink supply systems (CISS).

The ink supply assembly 200 further includes a drive controller 216 coupled to the drive rack 202. In an example implementation, the drive controller 216 may be implemented as hardware, such as a processor(s) or through logical instructions or a combination thereof. The processor(s) may be implemented as microprocessors, microcomputers, microcontrollers, digital signal processors, central processing units, state machines, logic circuitries, and/or any devices that manipulate signals based on operational instructions. The drive controller 216 may perform various functions for the purpose of triggering motion of the drive rack 202, in accordance with the present subject matter. In an example implementation, the drive controller 216 may be coupled to the CNC stages which may be mechanically coupled to the drive rack 202, through gear assemblies (not shown), to enable movement of the drive rack 202. The drive shafts 204 guide and control the movement of the drive rack 202.

The drive controller 216 is operable to trigger movement of the drive rack 202 in a first direction, as indicated by arrow A, when the ink regulator, for example the ink regulator 108, has a volume of ink less than a predefined threshold. In an example implementation, the predefined threshold is 5%-10% of the full capacity of the ink regulator. When the drive rack 202 is moved in the first direction, the plurality of guide pins 208 enable alignment of the fluidic interconnect 206 with an inlet port of an ink regulator, for example, the inlet port 110 of the ink regulator 108. The movement of the drive rack 202 in the first direction is to engage the fluidic interconnect 206 with the inlet port of the ink regulator.

When a prescribed volume of ink has been supplied to the ink regulator (not shown), the drive controller 216 is operable to trigger movement of the drive rack 202 in the second direction, as indicated by arrow B. In an example implementation, the prescribed volume is 90%-95% of the full capacity of the ink regulator. The movement of the drive rack 202 in the second direction is to dis-engage the fluidic interconnect 206 from the inlet port of the ink regulator.

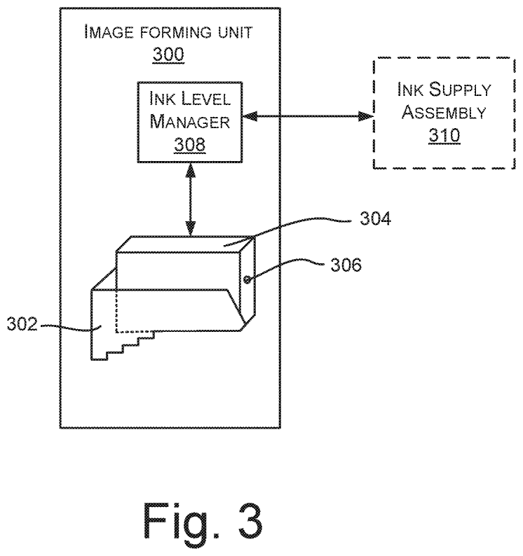

FIG. 3 illustrates an image forming unit 300 of a printing device, according to an example implementation of the present subject matter. The image forming unit 300 includes a carriage 302. The carriage 302 may be mounted on a shaft (not shown) and can move along a length of the shaft for performing printing operations on a print medium. A printhead (not shown) may be mounted on the carriage 302.

The image forming unit 300 includes an ink regulator 304 mounted on the carriage 302. The ink regulator 304 may be coupled to the printhead and may provide ink to the printhead for printing. The ink regulator 304 has an inlet port 306. In an example implementation, the ink regulator 304 may also have an outlet port (not shown). The inlet port 306 and the outlet port may be configured to receive a fluidic interconnect, for example the fluidic interconnect 104 of FIG. 1, during engagement of the fluidic interconnect with the inlet/outlet port.

The image forming unit 300 further includes an ink level manager 308 coupled to the ink regulator 304. In an example implementation, the ink level manager 308 may be implemented as hardware, such as a processor(s) or through logical instructions or a combination thereof. The processor(s) may be implemented as microprocessors, microcomputers, microcontrollers, digital signal processors, central processing units, state machines, logic circuitries, and/or any devices that manipulate signals based on operational instructions. The ink level manager 308 may perform various functions for the purpose of determining a level of ink in the ink regulator 304 and accordingly generate control signals for operating different components/units of the printing device.

The ink level manager 308 is coupled to an ink supply assembly 310 of the printing device. The ink supply assembly 310 may include features of the ink supply assembly 200. In an example implementation, the ink level manager 308 may be coupled to a drive controller of the ink supply assembly, for example, the drive controller 216 of the ink supply assembly 200 of FIG. 2, and may communicate with the ink supply assembly by sending control signals to the drive controller. Also, the ink level manager 308 may be coupled to an ink circulation unit, for example the ink circulation unit 210, and generate control signals for operating components in the ink circulation unit.

In an example implementation, a level/volume of ink in the ink regulator 304 may be determined by the ink level manager 308. In an example implementation, sensors (not shown) may be coupled to the ink regulator 304 and the output of such sensors may be provided to the ink level manager 308. The ink level manager 308 may determine whether the ink regulator 304 has a volume of ink upto a predefined threshold, based on the output of the sensors. In an example implementation, the volume of ink in the ink regulator 304 may be determined by the ink level manager 308 by monitoring number of drops of ink being ejected from the ink regulator 304. Based on the number of drops of ink being ejected and an average volume of each drop of ink, the ink level manager 308 may determine the total volume of ink being ejected and estimate the volume of ink remaining in the ink regulator 304. In another example implementation, the ink level manager 308 may determine the volume of ink in the ink regulator 304 based on flowrate of a pump, for example the pump 212, which is used to transfer ink from an ink reservoir to the ink regulator 304.

When the ink level manager 308 determines that the ink regulator 304 has a volume of ink less than a predefined threshold, the ink level manager 308 sends a first signal to the ink supply assembly 310. In an example implementation, the predefined threshold is 5%-10% of the full capacity of the ink regulator 304 and value of the predefined threshold may be preset in the ink level manager 308. The first signal is indicative of triggering engagement of a fluidic interconnect of an ink supply assembly, for example the fluidic interconnect 206 of the ink supply assembly 310, with the inlet port 306 to supply ink to the ink regulator 304. In an example implementation, the ink level manager 308 may send the first signal to a drive controller of an ink supply assembly, for example the drive controller 216 of the ink supply assembly 200 of FIG. 2. The drive controller on receiving the first signal may trigger movement of the drive rack, for example the drive rack 202 of FIG. 2, for engagement of the fluidic interconnect with the inlet port 306.

When the ink level manager 308 determines that a prescribed volume of ink has been supplied to the ink regulator, the ink level manager 308 sends a second signal to the ink supply assembly 310. In an example implementation, the prescribed volume of ink is 90% to 95% of the full capacity of the ink regulator 304 and value of the prescribed volume of ink may be preset in the ink level manager 308. The second signal is indicative of triggering disengagement of the fluidic interconnect from the inlet port 306. In an example implementation, the ink level manager 308 may send the second signal to a drive controller of an ink supply assembly, for example the drive controller 216 of the ink supply assembly 200 of FIG. 2. The drive controller on receiving the second signal may trigger movement of the drive rack, for example the drive rack 202 of FIG. 2, for disengagement of the fluidic interconnect from the inlet port 306.

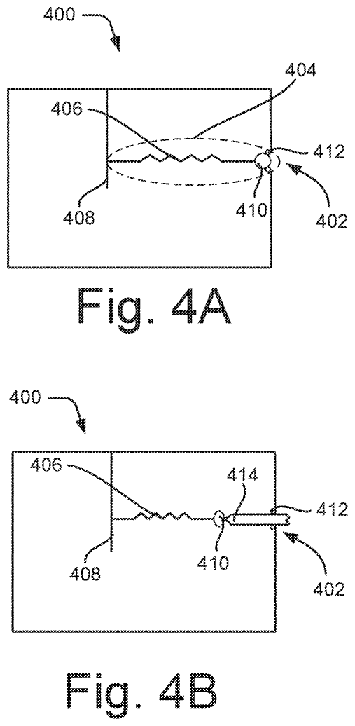

FIGS. 4A and 4B illustrate an ink regulator 400, according to an example implementation of the present subject matter. The ink regulator 400 has an inlet port 402 similar to the inlet port 306. A sealing assembly 404 is positioned inside the ink regulator 400 at the inlet port 402. The sealing assembly 404 includes a resilient element 406. In an example implementation, the resilient element 406 may be a spring. One end of the resilient element 406 may be coupled to a support structure 408 within the ink regulator 400. The support structure 408 may be a portion of a wall of the ink regulator 400. The sealing assembly 404 also includes a stopper element 410 coupled to the other end of the resilient element 406. In an example implementation, the stopper element 410 may have a spherical shape and may be formed from metal or plastic. When the resilient element 406 is relaxed, the stopper element 410 may rest on a seat formed by an O-ring or gasket 412 at the inlet port 402 thereby sealing the inlet port 402.

In an example implementation, a sealing assembly, similar to the sealing assembly 404 may also be positioned inside the ink regulator 304 of FIG. 3 at the inlet port 306.

FIG. 4A illustrates the ink regulator 400 when a fluidic interconnect of an ink supply assembly, for example the fluidic interconnect 206 of the ink supply assembly 200, is not engaged with the inlet port 402. The sealing assembly 404 seals the inlet port 402 when the fluidic interconnect is not engaged with the inlet port 402.

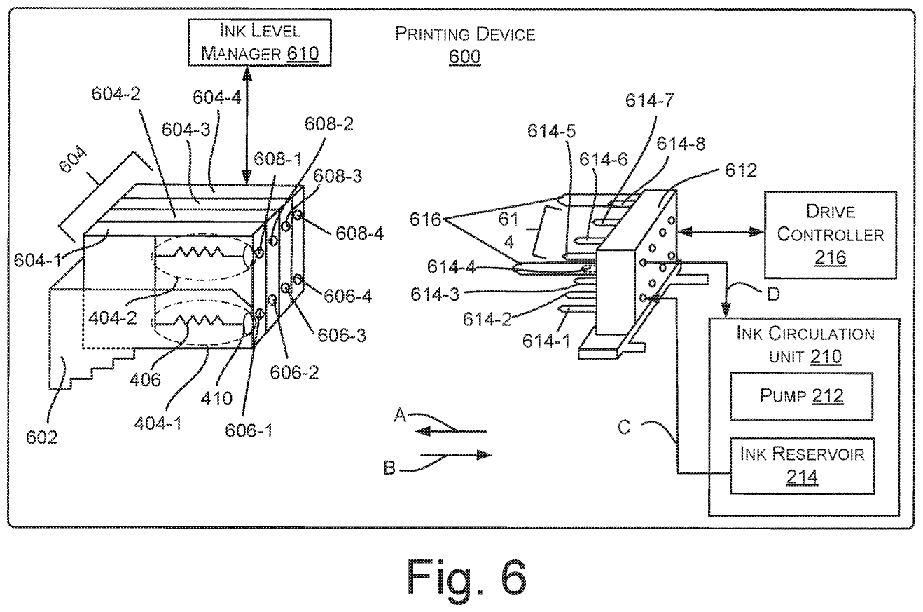

With reference to FIG. 4B, the sealing assembly 404-1 is shown when a fluidic interconnect 414, similar to the fluidic interconnect 104 is engaged with the inlet port 402. When the fluidic interconnect 104 is engaged with the inlet port 402, the stopper element 410 interfaces with the fluidic interconnect 414 and moves to bias the resilient element 406. The operation of the sealing assembly is explained later in detail in conjunction with FIG. 6.

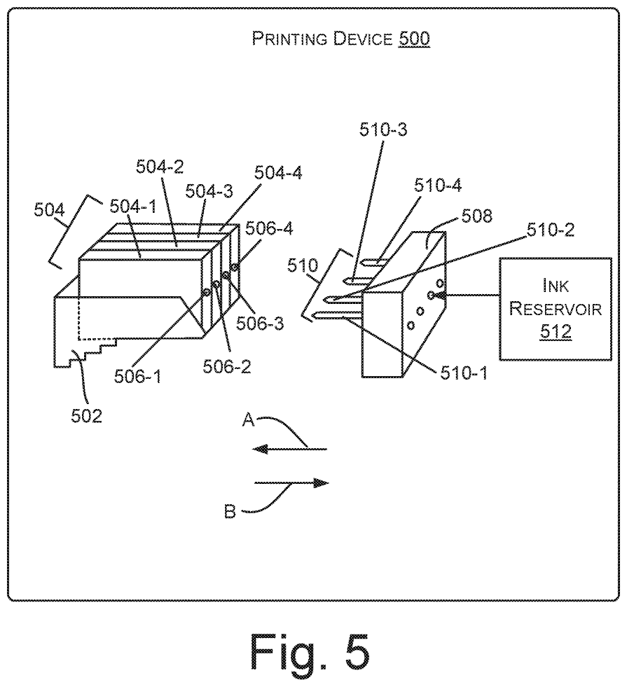

FIG. 5 illustrates a printing device 500, according to an example implementation of the present subject matter. The printing device 500 includes a carriage 502. In an example implementation, the carriage 502 is similar to the carriage 302 of FIG. 3. The printing device 500 also includes an ink regulator assembly 504 mounted on the carriage 502. The ink regulator assembly 504 includes a plurality of ink regulators 504-1,504-2, 504-3, and 504-4. Each of the ink regulators, 504-1 to 504-4, may be similar to the ink regulator 304 of FIG. 3. Each of the ink regulators, 504-1 to 504-4, have respective inlet ports 506-1 to 506-4, each inlet port being similar to the inlet port 306 of FIG. 3. Although in FIG. 5, the ink regulator assembly 504 is shown to include four ink regulators, in an example implementation, the ink regulator assembly may include more than four ink regulators or less than four ink regulators.

The printing device 500 also includes a drive rack 508 similar to the drive rack 102 of FIG. 1. The printing device 500 further includes a fluidic interconnect assembly 510 mounted on the drive rack 508. The fluidic interconnect assembly 510 includes a plurality of fluidic interconnects, 510-1 to 510-4, each being similar to the fluidic interconnect 104 of FIG. 1. The fluidic interconnects, 510-1 to 510-4, correspond to the ink regulators 504-1 to 504-4 and the ports thereof. The printing device 500 also includes an ink reservoir 512. The fluidic interconnects, 510-1 to 510-4, are couplable to the ink reservoir 512.

When at least one of the ink regulators, 504-1 to 504-4, has a volume of ink less than a predefined threshold, the drive rack 508 is operated to move the fluidic interconnect assembly 510 in a first direction, as indicated by arrow A, to engage each of the fluidic interconnects, 510-1 to 510-4, with the respective inlet ports 506-1 to 506-2 of the ink regulators 504-1 to 504-4, In an example implementation, the predefined threshold is about 5%-10% of the full capacity of the ink regulator. This engagement between of the fluidic interconnects and the inlet ports enables ink to be supplied from the ink reservoir 512 and to be filled into the at least one ink regulator which has the volume of ink less than the predefined threshold.

In an example implementation, after supplying the ink in the at least one ink regulator, the drive rack 508 is operated to move the fluidic interconnect assembly 510 in a second direction, as indicated by arrow B, to disengage the fluidic interconnects, 510-1 to 510-4, respective inlet ports 506-1 to 506-2 of the ink regulators 504-1 to 504-4. In an example implementation, the second direction is opposite to the first direction as also depicted through arrows A and B.

FIG. 6 illustrates a printing device 600, according to another example implementation of the present subject matter. The printing device 600 incudes a carriage 602 similar to the carriage 502 of FIG. 5. An ink regulator assembly 604 is mounted on the carriage 602. The ink regulator assembly 604 includes ink regulators 604-1, 604-2, 604-3, and 604-4. Although in FIG. 6, the ink regulator assembly 604 is shown to include four ink regulators, in an example implementation, the ink regulator assembly may include more than four ink regulators or less than four ink regulators.

Each of the ink regulators 604-1, 604-2, 604-3, and 604-4 has corresponding inlet ports 606-1, 606-2, 606-3, and 606-4, respectively. Further, each of the ink regulators 604-1, 604-2, 604-3, and 604-4 has corresponding outlet ports 608-1, 608-2, 608-3, and 608-4, respectively. Ink is flowed into the ink regulators 604-1 to 604-4 through their respective inlet ports 606-1 to 606-4 and a mixture of air and ink may be drawn out from the ink regulators 604-1 to 604-4 through their respective outlet ports 608-1 to 608-4.

With reference to FIG. 6, the ink regulator 604-1 is shown to include sealing assemblies 404-1 and 404-2 similar to the sealing assembly 404. The sealing assembly 404-1 is positioned at the inlet port 606-1 of the ink regulator 604-1 and the sealing assembly 404-2 is positioned at the outlet port 608-1 of the ink regulator 604-1. Similar sealing assemblies are also present at corresponding inlet and outlet ports of the ink regulators 604-2 to 604-4, but not visible in FIG. 6.

The printing device 600 also includes an ink level manager 610 similar to the ink level manager 308 of FIG. 3. The ink level manager 610 may be coupled to the ink regulator assembly 604, to determine level/volume of ink in the ink regulators, 604-1 to 604-4 and may generate control instructions for operating various components and units of the printing device 600.

The printing device 600 also include the features of the ink supply assembly 200 illustrated through FIG. 2. The same reference numbers, as used in FIG. 2, are used in FIG. 6 and the following description, to refer to the same or similar features.

As shown in FIG. 6, the printing device 600 includes a drive rack 612. The drive rack 612 is similar to the drive rack 202 of FIG. 2 and is adapted to carry a fluidic interconnect assembly 614 mounted on the drive rack 612. The fluidic interconnect assembly 614 includes two sets of fluidic interconnects 614-1 to 614-4 and 614-5 to 614-8 corresponding to the ink regulators 604-1 to 604-4 at their inlet and outlet ports. A first set of fluidic interconnects 614-1 to 614-4 is aligned along a straight line and may engage with the inlet ports 606-1 to 606-4, and a second set of fluidic interconnects 642-5 to 614-8 is aligned along another straight line and may engage with the outlet ports 608-1 to 608-4. Each of the fluidic interconnects, 614-1 to 614-8, is similar to the fluidic interconnect 206 of FIG. 2. The drive rack 612 also has a plurality of guide pins 616 integral to the drive rack 612 for alignment of the fluidic interconnects 614-1 to 614-8 with the respective ports in the ink regulators 604-1 to 604-4. The guide pins 616 are similar to the guide pins 208 of FIG. 2.

During operation of the printing device 600, the ink level manager 610 can determine whether at least one of the ink regulators, 604-1 to 604-4, is low on ink, i.e., it has a volume of ink less that a predefined threshold. In an example implementation, the predefined threshold may be 5%-10% of the full capacity of the ink regulator and may be preset in the ink level manager 610. The ink level manager 610 can determine the level/volume of ink in the ink regulators 604-1 to 604-4 through use of sensors or through other techniques, as previously mentioned in the description of FIG. 3.

Upon determining that the ink regulator 604-1 is low on ink, the ink level manager 610 may generate a first signal. The first signal is indicative of triggering engagement of the first set of fluidic interconnects 614-1 to 614-4, with the inlet ports 606-1 to 606-4 of the ink regulators 604-1 to 604-4 and engagement of the second set of fluidic interconnects, 614-1 to 614-4, with the outlet ports, 608-1 to 608-4, of the ink regulators, 604-1 to 604-4.

In an example implementation, the first signal may be sent to the drive controller 216 coupled to the drive rack 612. The drive controller 216, on receiving the first signal, may trigger movement of the drive rack 612 in a first direction, indicated by arrow A. As the drive rack 612 moves in the first direction, the fluidic interconnect assembly 614 is also moved in the first direction to engage the fluidic interconnects 614-1 to 614-8 with the corresponding inlet/outlet ports of the ink regulators 604-1 to 604-4.

In an example implementation, the ink regulator assembly 604 comprises a housing (not shown) having a plurality of locator holes or openings adapted to receive the guide pins 616. When the fluidic interconnect assembly 614 is moved in the first direction each of the plurality of guide pins 616 pass through a locator hole (not shown), from the plurality of locator holes, to align the fluidic interconnects, 614-1 to 614-8, with inlet or outlet ports of corresponding ink regulators 604-1 to 604-4.

In an example implementation, the guide pins 616 may align the first set of fluidic interconnects, 614-1 to 614-4, with the corresponding inlet ports, 606-1 to 606-4, of the ink regulators, 604-1 to 604-4. The guide pins 616 also align the second set of fluidic interconnects, 614-5 to 614-8, with the corresponding outlet ports, 608-1 to 608-4, of the ink regulators, 604-1 to 604-4.

Once the fluidic interconnects 614-1 to 614-8 are aligned with corresponding inlet/outlet ports of the, movement of the drive rack 612 further in the first direction, causes the first set of fluidic interconnects, 614-1 to 614-4, to pass through the inlet ports 606-1 to 606-4 and the second set of fluidic interconnects, 614-5 to 614-8, to pass through the outlet ports 608-1 to 608-4.

The technique in which the fluidic interconnects engage/disengage with the ports is described with reference to the fluidic interconnect 614-1 which passes through the inlet port 606-1 of the ink regulator 604-1. The other fluidic interconnects 614-2 to 614-8 may engage with the ports of the ink regulator in a similar fashion. During engagement of the fluidic interconnect 614-1 with the inlet port 606-1, as the fluidic interconnect 614-1 passes through the inlet port 606-1, the stopper element 410 interfaces with the fluidic interconnect 614-1. The stopper element 410 is moved by the fluidic interconnect 614-1, such that the stopper element 410 biases or compresses the resilient element 406, as shown in FIG. 4B.

After engagement of the fluidic interconnects with the ports of the ink regulators, the ink level manager 610 may operate the pump 212 of the ink circulation unit 210 to supply a prescribed volume of ink to the ink regulator 604-1. In an example implementation, the prescribed volume may be 90%-95% of the full capacity of the ink regulator 604-1 and may be preset in the ink level manager 610 at the time of assembly of the printing device 600. In an example implementation, when the pump 212 is operated, the pump 212 may drive ink, as indicated by link C, from the ink reservoir 214 through the fluidic interconnect 614-1 into the ink regulator 604-1 and may draw out a mixture of air and ink, as indicated by link D, from the ink regulator 604-1, through the fluidic interconnect 614-5, into the ink circulation unit 210.

When the ink level manager 610 determines that the prescribed volume of ink has been supplied to the ink regulator 604-1, the ink level manager 610 may generate a second signal. The second signal is indicative of triggering disengagement of the first set of fluidic interconnects 614-1 to 614-4, from the inlet ports 606-1 to 606-4 of ink regulators 604-1 to 604-4 and disengagement of the second set of fluidic interconnects, 614-5 to 614-8, from the outlet ports, 608-1 to 608-4, of the ink regulators, 604-1 to 604-4.

In an example implementation, the second signal may be sent to the drive controller 216 coupled to the drive rack 612. The drive controller 216, on receiving the second signal, may trigger movement of the drive rack 612 in a second direction, indicated by arrow B. As the drive rack moves in the second direction, the fluidic interconnect assembly 614 is also moved in the second direction to disengage the fluidic interconnects, 614-1 to 614-8, from inlet/outlet ports of the corresponding ink regulators.

During disengagement of the fluidic interconnect 614-1 from the inlet port 606-1, as the fluidic interconnect 614-1 moves in the second direction, the resilient element 406 gets unbiased or relaxed thereby moving the stopper element 410 towards the inlet port 606-1 to seal the inlet port 606-1.

Although implementations of ink supply assembly for a printing device, image forming unit of a printing device, and printing device having such ink supply assembly and image forming unit have been described in language specific to structural features and/or methods, it is to be understood that the present subject matter is not limited to the specific features or methods described. Rather, the specific features and methods are disclosed and explained as example implementations for ink supply assembly for a printing device, image forming unit of a printing device, and printing device having such ink supply assembly and image forming unit.

We claim:

1. An ink supply assembly for a printing device, comprising:
a drive rack; and
a fluidic interconnect mounted on the drive rack, wherein the fluidic interconnect is couplable to an ink reservoir, and wherein the drive rack is to:
move the fluidic interconnect in a first direction to engage the fluidic interconnect with an inlet port of an ink regulator of the printing device to supply ink from the ink reservoir to the ink regulator; and
move the fluidic interconnect in a second direction to disengage the fluidic interconnect from the inlet port after supplying the ink to the ink regulator.

2. The ink supply assembly as claimed in claim 1, wherein the drive rack comprises a plurality of guide pins to align the fluidic interconnect with the inlet port when the fluidic interconnect is moved in the first direction.

3. The ink supply assembly as claimed in claim 1, further comprising a drive controller coupled to the drive rack, wherein the drive controller is to trigger movement of the drive rack in the first direction when the ink regulator has a volume of ink less than a predefined threshold.

4. The ink supply assembly as claimed in claim 3, wherein the drive controller is to trigger movement of the drive rack in the second direction when a prescribed volume of ink has been supplied to the ink regulator.

5. The ink supply assembly as claimed in claim 1, wherein the ink supply assembly comprises the ink reservoir.

6. The ink supply assembly as claimed in claim 1, wherein the fluidic interconnect is a linearly extending rigid conduit for transporting ink.

7. An image forming unit of a printing device, comprising:
a carriage;
an ink regulator mounted on the carriage, the ink regulator having an inlet port; and
an ink level manager coupled to the ink regulator, wherein the ink level manager is to:
send a first signal to an ink supply assembly of the printing device when the ink regulator has a volume of ink less than a predefined threshold, wherein the first signal is indicative of triggering engagement of a fluidic interconnect of the ink supply assembly with the inlet port, to supply ink to the ink regulator; and
send a second signal to the ink supply assembly when a prescribed volume of ink has been supplied to the ink regulator, wherein the second signal is indicative of triggering disengagement of the fluidic interconnect from the inlet port.

8. The image forming unit as claimed in claim 7, further comprising a sealing assembly positioned, inside the ink regulator, at the inlet port, to seal the inlet port when the fluidic interconnect is disengaged from the inlet port.

9. The image forming unit as claimed in claim 8, wherein the sealing assembly comprises:
a resilient element; and
a stopper element coupled to the resilient element;
wherein the stopper element interfaces with the fluidic interconnect during engagement of the fluidic interconnect with the inlet port, the stopper element being moved by the fluidic interconnect, such that the stopper element is to bias the resilient element by the movement, and the resilient element is unbiased to move the stopper element to seal the inlet port during disengagement of the fluidic interconnect from the inlet port.

10. A printing device comprising:
a carriage;
an ink regulator assembly mounted on the carriage, the ink regulator assembly comprising a plurality of ink regulators, each having an inlet port;
an ink reservoir;
a drive rack; and
a fluidic interconnect assembly mounted on the drive rack and couplable to the ink reservoir, the fluidic interconnect assembly comprising a plurality of fluidic interconnects corresponding to the plurality of ink regulators, wherein the drive rack is to:
move the fluidic interconnect assembly in a first direction to engage each of the plurality of fluidic interconnects with an inlet port of a corresponding ink regulator to supply ink to at least one of the plurality of ink regulators; and
move the fluidic interconnect assembly in a second direction, different from the first direction, to disengage each of the plurality of fluidic interconnects from the inlet port of the corresponding ink regulator after supplying the ink in the at least one of the plurality of ink regulators.

11. The printing device as claimed in claim 10, further comprising a drive controller coupled to the drive rack, wherein the drive controller is to trigger movement of the drive rack in the first direction when the at least one of the plurality of ink regulators has a volume of ink less than a predefined threshold.

12. The printing device as claimed in claim 11, wherein the drive controller is to trigger movement of the drive rack in the second direction when a prescribed volume of ink has been supplied to the at least one of the plurality of ink regulators.

13. The printing device as claimed in claim 10, further comprising an ink level manager coupled to the ink regulator assembly, wherein the ink level managers is to:
determine whether the at least one of the plurality of ink regulators has a volume of ink less than a predefined threshold;
upon determining that the at least one of the plurality of ink regulators has the volume of ink less than the predefined threshold, generate a first signal indicative of triggering engagement of each of the plurality of fluidic interconnects with the inlet port of the corresponding ink regulator; and
operate a pump to supply a prescribed volume of ink to the at least one of the plurality of ink regulators.

14. The printing device as claimed in claim 10, wherein the drive rack comprises a plurality of guide pins to align the plurality of fluidic interconnects with the corresponding inlet ports, when the fluidic interconnect assembly is moved in the first direction.

15. The printing device as claimed in claim 14, wherein the ink regulator assembly comprises a housing having a plurality of locator holes, such that each of the plurality of guide pins of the drive rack is to pass through a locator hole, from the plurality of locator holes, to align the plurality of fluidic interconnects with the corresponding inlet ports.
